(19) United States
(12) Patent Application Publication
(10) Pub. No.: US 2025/0330934 A1
(43) Pub. Date: Oct. 23, 2025

(54) METHODS FOR PROVIDING ADVANCED REACHABILITY IN A WIRELESS SYSTEM

(71) Applicant: InterDigital Patent Holdings, Inc., Wilmington, DE (US)

(72) Inventors: Zhibi Wang, Woodbridge, IL (US); Michel Roy, Candiac (CA); Ulises Olvera-Hernandez, Saint-Lazare (CA); Samir Ferdi, Kirkland (CA); Michelle Perras, Montreal (CA); Mohamad Kenan Al-Hares, Canterbury (GB)

(73) Assignee: InterDigital Patent Holdings, Inc., Wilmington, DE (US)

(21) Appl. No.: 18/644,028

(22) Filed: Apr. 23, 2024

(51) Int. Cl. H04W 60/04; H04W 8/22; H04W 12/06

(52) U.S. Cl. CPC H04W 60/04; H04W 8/22; H04W 12/06

(57) ABSTRACT

A first wireless transmit/receive unit (WTRU) may send a call request to an AMF. The call request may indicate a known identifier to reach a second WTRU. The first WTRU may receive a call response that indicates a call rejection and/or that the second WTRU has configured alternate reachability methods. The first WTRU may send a reachability request to a reachability management function (RMF). The reachability request may include a known identifier, an identifier of the first WTRU, and/or information about one or more capabilities of the first WTRU. The first WTRU may receive a reachability response from the RMF that indicates the second WTRU can connect with the first WTRU. The reachability response may include information to connect with the first WTRU. The first WTRU may send a call request to an AS. The first WTRU may receive a call response that indicates a call is established.

### BACKGROUND

A UE may use one or more devices associated with different access technologies. Users may have one or more connected devices with different access technologies including (e.g., both) 3GPP and/or non-3GPP communication devices. Each device may have different device IDs. The device IDs may be static and/or dynamic, for example, based on context and/or usage, based on subscription, and/or the like.

### SUMMARY

The reachability management function (RMF) may be a service for providing user reachability capabilities. The RMF may have an architecture that allows a reachable user to manage and/or configure its reachability in a network environment. The RMF architecture may allow association of alternative devices, application, domain identifiers with a unique user identifier. The RMF architecture may allow association of permissions and rules that influence how a reachable user may be reached. The RMF architecture may provide capabilities for establishing communication between users, for example, without sharing identifiers openly to preserve privacy. The RMF architecture may provide subscription capabilities for being notified of changes related to reachability. The RMF architecture may enable the association of aliases with a reachable user.

A first wireless transmit/receive unit (WTRU may send a reachability request to an RMF. For example, the first WTRU may send the reachability request to a RMF in response to receiving the indication that the second WTRU has one or more configured alternate reachability methods. The reachability request may include the information associated with the first WTR (e.g., known identifier, an identifier of the first WTRU, and/or information about one or more capabilities of the first WTRU). The first WTRU may receive a reachability response from the RMF that indicates the second WTRU is able to connect with the first WTRU via one of the one or more configured alternate reachability methods. The reachability response may include a alternate reachability information (e.g., TSR token) to connect the first WTRU with the second WTRU via one of the one or more configured alternate reachability methods. The first WTRU may send a call request to an application server (AS) and/or application function (AF) using information associated with the alternate reachability information. The first WTRU may receive a call response that indicates a call is established. The first WTRU may send a second call request to an access and mobility management function (AMF). The call request may indicate a known identifier to reach a second WTRU. The first WTRU may receive a second call response. The second call response may indicate a call rejection and/or that the second WTRU has one or more configured alternate reachability methods. The reachability request may be triggered by reception of the first call response. The second call request may be sent before the first call request. The second call response may be received before the first call response.

The call request sent to the AMF may be triggered by a user. The call response further include information about the RMF. The first WTRU may send the reachability request based on RMF information received or based on the call rejection. The first WTRU may receive the alternate reachability information (e.g., TSR token) at an application client (AC) residing on the first WTRU. The first WTRU may determine the AC based on information associated with the alternate reachability information (e.g., TSR token). The first WTRU may send the call request to the AS based on information associated with the alternate reachability information (e.g., TSR) token. The call response may include an indication to a user that the call is established. The alternate reachability information may include a temporary secure reachability (TSR) token. The TSR token may include authentication information to establish the call associated with the first WTRU and/or second WTRU. The alternate reachability information may include validity conditions that indicate the alternate reachability information validity for establishing a connection between the first WTRU and the second WTRU. The alternate reachability information may include privacy information associated with the first WTRU and/or the second WTRU. The privacy information may include an anonymous ID associated with the second WTRU. The first WTRU may use the anonymous ID to establish the call with the second WTRU.

Embodiments described herein may include a method performed by an RMF. The method may include receiving a reachability request from a first wireless transmit/receive unit (WTRU) to establish a call with a second WTRU. The reachability request may include one or more identifiers associated with the first WTRU, second WTRU, and/or information associated with one or more capabilities of the first WTRU. The method may include sending a reachability notification to an AF. The reachability notification may include an indication to connect the first WTRU with the second WTRU via one or more configured alternate reachability methods. The method may include receiving a reachability notification response from the AF. The reachability notification response may include alternate reachability information (e.g., TSR token) to use to connect the first WTRU with the second WTRU (e.g., via one of the one or more configured alternate reachability methods). The method may include sending a reachability response to the first WTRU. The reachability response may indicate that the first WTRU is connected to the second WTRU. The second WTRU may register its devices and rules with the RMF concerning who/where/when/how the second WTRU can be reached. The RMF requests from networks to be notified and receives updates of the reachability of the second WTRU.

The one or more configured alternate reachability methods may include a common alternative communication method. The method may further include determining the common alternative communication method for the first WTRU and the second WTRU based on one or more of a registered alternative method of the one or more configured alternate reachability methods or one or more capabilities of the first WTRU and/or of the second WTRU. The method may include determining the AF based on the determine alternative communication method. The method may include determining an identity of the second WTRU pre-provisioned by the second WTRU as an alternative communication method. The alternate reachability information may include an anonymous identifier of the second WTRU and/or authentication information to connect the first WTRU with the second WTRU. The method may include receiving the reachability request from the first WTRU. The reachability request may be received based on information sent to the first WTRU and/or based on a call rejection. The method may include using RMF registration information to connect the first WTRU with the second WTRU. The RMF registration information may include RMF device information, RMF connectivity information, RMF application information, RMF identity information, and/or RMF reachability preferences. The alternate reachability information may include validity conditions. The method may include using the validity conditions to connect the first WTRU with the second WTRU. The alternate reachability information may include information associated with one or more of: resource owner, alternate identifier, alternate identifier issuer, privileges, type, expiration, issuer, subject, audience, and/or scope. The method may include determining whether the first WTRU is authorized to connect with the second WTRU (e.g., based on operator policies and/or rules). The alternate reachability information may include privacy information associated with the first WTRU and/or the second WTRU. The privacy information may include an anonymous identification (ID) associated with the second WTRU. The method further may include using the anonymous ID to establish the call with the second WTRU. The alternate reachability information may include a temporary secure reachability (TSR) token. The TSR token may include authentication information to establish the call associated with the first WTRU and/or the second WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a call flow diagram that illustrates an example process for a WTRU connection establishment via an alternative reachability method from a reachability management function (RMF).

FIG. 3 is a call flow diagram that illustrates an example process of RMF alternative reachability connection establishment by a network consumer (e.g., AMF).

### DETAILED DESCRIPTION

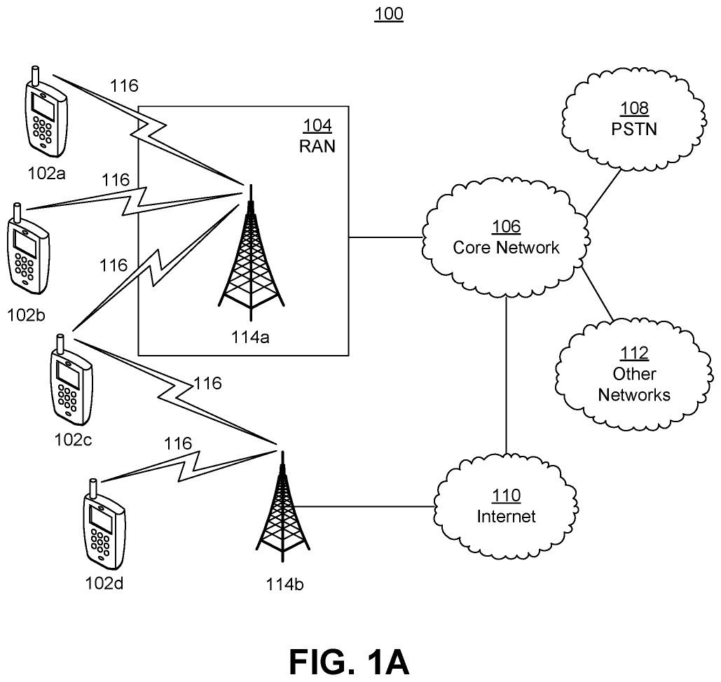

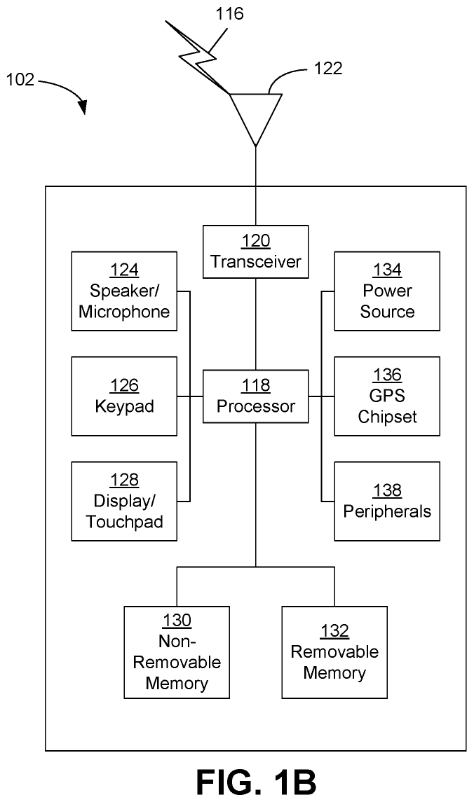

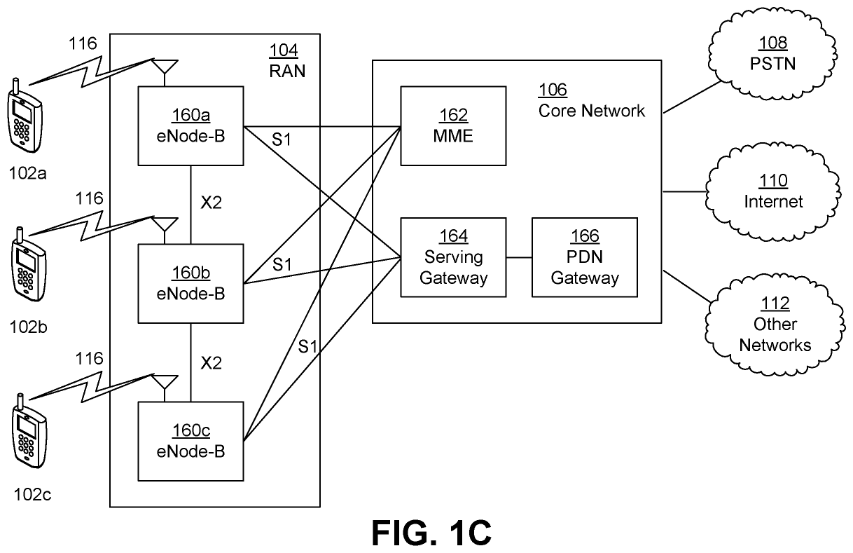

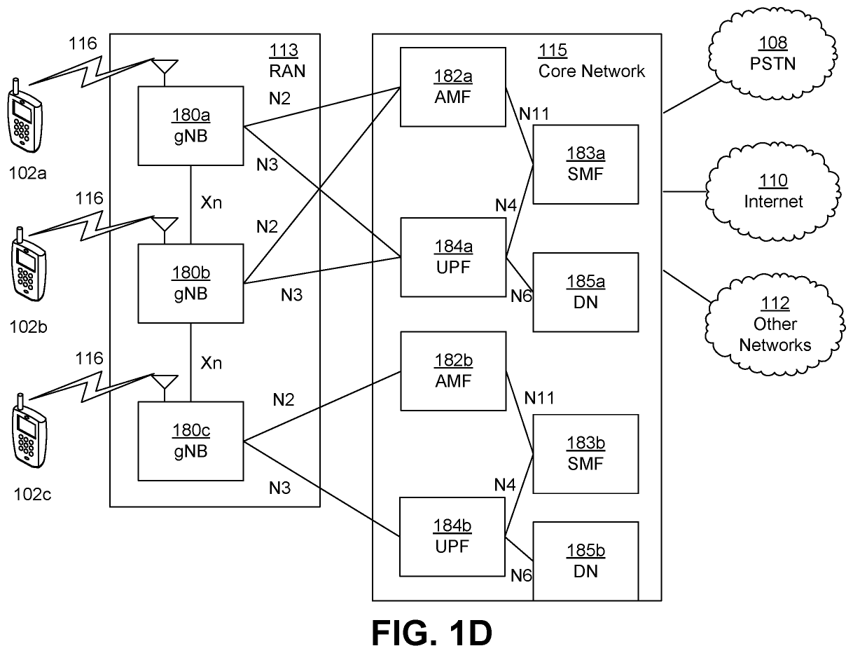

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

One or more of the following abbreviations and/or acronyms may be included herein: 6G System (6GS); Application Function (AF); Access and Mobility Management Function (AMF); Network Exposure Function (NEF); Network Function (NF); Reachability Management Function (RMF); Unified Data Management (UDM); and/or Temporary Secure Reachability (TSR) (e.g., token).

Embodiments may be described herein with respect to alternate reachability by a UE consumer (e.g., a user who owns the UE). A calling UE (e.g., first WTRU) may perform one or more of the actions as described herein. The calling UE may send a call request to the network. The call request may be triggered by a user. The call request may include a known identifier to reach a reachable UE. The calling UE may receive a call response indicating a call rejection. The call response may indicate that the reachable UE has configured one or more alternate reachability methods, and/or may include information about the RMF. The alternate reachability methods (e.g., communication media, messaging services, multimedia services, and/or application layer software services) may include different types of communication media, messaging services, multimedia services, and/or application layer software services. For example, communication media may include cellular communication media (e.g., 3G, 4G, 5G, etc.), WiFi communication media (e.g., voice-over-IP (VoIP)), etc.), and/or other communication media performed via different communication protocols and/or bandwidths. Example messaging services may include text messaging and/or instant messaging services. Text messaging services may use cellular communication media. Instant messaging services may use WiFi or other communication media to access the Internet. Text messaging and instant messaging services may have different character restrictions. Example application layer software services may include social media software services, communication media software applications, and/or simple mail transfer protocol (SMTP) services (e.g., email services). The calling UE may send a reachability request to the RMF. The reachability request may be triggered based on RMF information received (e.g., as described herein) and/or by the call rejection (e.g., assuming that RMF information is known). The reachability request may include the known identifier, the calling UE identifier, and/or information about the calling UE capabilities. The calling UE may receive a reachability response from the RMF. The reachability response may include alternate reachability information and/or a temporary secure reachability (TSR token) (e.g., as described herein). The alternate reachability information and/or TSR token may be provided to an application client (AC) residing on the UE. The AC may be determined based on the alternate reachability information and/or the TSR token information. The calling UE may send a call request to an application server (AS). The call request may be triggered based on the alternate reachability information and/or the TSR token information received, as described herein. The AS may be determined based on the alternate reachability information and/or the TSR token information. The calling UE may receive a successful call response (e.g., call establishment response). The call response may indicate that a call was successfully achieved using the alternate reachability method (e.g., communication media, messaging services, multimedia services, and/or application layer software services). The call response may indicate to the user that the call is established. The one or more actions performed by the calling UE may be part of an alternative call establishment procedure. The calling user may be informed about the success or failure of the call after a calling UE receives a successful or failure call response of the alternate reachability method. The alternate reachability information may include a TSR token. The alternate reachability information may be included in a TSR token. A calling UE may receive alternate reachability information and/or TSR token about one or more (e.g., several) alternate reachability methods in order of priority and/or may (e.g., attempt to) establish a connection using one or more alternate reachability methods.

An RMF may perform one or more of the actions described herein. The RMF may receive a reachability request. The reachability request may be triggered by a calling UE trying to call a reachable user. The reachability request may include a known identifier of a reachable UE, a calling UE identifier, and/or information about the calling UE capabilities. For example, the first UE's reachability may be included in the request to the RMF. The RMF may determine a match of the reachable UE's reachability. If the reachability from the RMF from the RMF response can not be used by the calling UE (e.g., if the calling UE does not support a certain software application), one or more requests may be sent to the RMF to get one or more alternative reachability methods. The RMF may determine a common alternative communication method for the calling UE and the reachable UE, for example based on a registered alternative method. The RMF may determine an AF, for example, based on the selected alternative communication method. The RMF may determine a reachable UE identity pre-provisioned by the reachable UE as an alternate communication method. The RMF may send a reachability notification to the determined AF. The reachability notification may indicate a desire to connect the calling UE with the reachable UE. The reachability notification may be based on the information received in the reachability request. The RMF may receive a reachability notification response from the determined AF. The reachability response may include alternate reachability information and/or a TSR token. The alternate reachability information and/or TSR token may include an anonymous identifier of the reachable UE. The RMF may send a reachability response to the calling UE. The reachability response may be triggered by receiving alternate reachability information and/or a TSR token from the AF. The reachability response may include the alternate reachability information and/or the TSR token.

A UE may use one or more devices associated with different access technologies. Users may have one or more connected devices with different access technologies, including 3GPP and/or non-3GPP communication devices, for example. Each device may have different device IDs. The device IDs may be static and/or dynamic, for example, based on context and/or usage, based on subscription, and/or the like.

A UE may have several identifiers assigned: one or more related to the 3GPP network, one or more related to non-3GPP network (e.g., Bluetooth, WiFi, etc.), and/or one or more related to the application being used on the UE.

A user of a UE may own one or more connected devices which may have their own IDs: these devices may be connected through the cellular network, WiFi network, and/or tethered via Bluetooth, universal series bus (USB), ethernet, etc. The devices owned by a user may have one or more communication capabilities, such as a personal computer (PC), a tablet,, a car, a watch, etc.

There may be different IDs, either temporary or permanent, encrypted and/or in clear text, from different devices and/or different protocols that can be associated with the same user, such as subscription concealed identifier (SUCI)/subscription permanent identifier (SUPI), globally unique temporary identifier (GUTI), generic public subscription identifier (GPSI), permanent equipment identifier (PEI), RAN layer temporary ID, 5G-serving(S)-temporary mobile subscriber identity (TMSI), internet protocol (IP) address, application layer IDs, key ID, generic bootstrapping architecture (GBA)/authentication and key management (AKMA) IDs, IDs in 3G/4G/5G.

To reach a user across different platforms and/or domains (e.g., devices, applications, networks, etc.), sharing a collection of different identifiers that may be associated with a user and/or platforms and/or domains may be included. Contacting a user may include knowing the one or more identifiers of a user and/or attempting to reach that user one or more platforms and/or domains.

A user may not know each identifier owned by a reachable user, and/or a reachable user may not (e.g., always) share (e.g., intentionally or not) one or more possible identifiers with other users. For example, a user may not be able to update each contact (e.g., known or unknown) when it uses a communication platform and/or domain and/or device. Additionally or alternatively, a user may choose not to share its identifier(s) with other users, for example, to preserve privacy. Although one or more platforms may enable the user to configure exceptions and/or filters regarding his/her reachability, this configuration may be platform dependent, and/or it may force the user to maintain one or more configuration profiles, based on the number platforms that may be used.

Reachability of a user may be largely based on a manual process initiated by a reachable user. The reachable user may share a collection of identifier(s) associated with one or more platforms and/or domains that it uses, The reachable user may determine who and/or how to share its identifiers with, and/or the reachable user may compromise its privacy each time it shares its identifiers (e.g., does not have control on what is done with the shared identifiers).

Advanced reachability capabilities may be provided to enable cross-platform and/or cross-domain reachability while maintaining privacy, as described herein. A first challenge may be related to enabling a caller to establish connectivity with a reachable user across platforms and/or domains without knowing each possible identifier associated with the reachable user. A second challenge may be related to allowing a reachable user to manage and/or configure its reachability and/or identifiers without interacting with each potential caller, and/or platform, while providing a level of granularity on reachability management and/or configuration. A third challenge may be related to providing privacy to the reachable user by privately maintaining its identifiers while enabling communication with the reachable user.

Systems, methods, and/or apparatuses described herein may include functions and/or information flows to provide reachability management in a wireless system. Certain implementations may include reaching a user over different devices, such implementation may require that the application server is configured with the proper device identifiers, supports one or more concurrent devices, and/or may be manually re-configured when identifiers change. Additionally or alternatively, the reachability may be limited to the same application/platform over different devices.

The reachability of a user may be based on a manual process that is initiated by a reachable user; this process may present challenges and/or issues (e.g., as described herein).

A reachable user may share a collection of identifiers associated with one or more devices and/or platforms and/or domains to be reached on these devices and/or platforms and/or domains. The reachable user may determine with who and/or how to share the collection of identifiers with, and/or to do so, it may know the potential identifiers of the users to share the information with. The reachable user may compromise its privacy each time it shares identifier(s) as there may be no control on the usage of the shared identifiers after they are shared.

The network architecture may provide opportunities to address user reachability challenges by providing other capabilities. The network may provide a reachability service via the RMF. The RMF may include a reachable user to manage and/or configure its reachability in a centralized environment. The RMF may provide a calling user to contact a reachable user without knowing each reachable user identifier, and/or may include preserving the calling user privacy by not sharing reachable user identifiers.

The architecture may include a reachable user to register one or more devices, applications, and/or domain identifiers with a user identifier. The architecture may include a reachable user to provision permissions and/or rules that may enable other users to contact the reachable user. The permission and/or rules may specify conditions (e.g., time, location, activity, and/or combined conditions with multiple attributes), and/or calling users. The permission(s), rules, conditions, and/or calling users may be used to determine a reachable user's availability. The architecture may provide capabilities for establishing communication between users without sharing the calling user and/or reachable user identifiers openly to preserve both user privacy. The exchange of alternate reachability information and/or TSR tokens with the calling and/or reachable user may be used to establish end-to-end connectivity without divulging the user identifiers. The architecture may provide subscription capabilities to get event notifications related to reachability, availability, and/or status changes related to reachability of a reachable user. The architecture may enable the use of aliases associated to a reachable user, which may enable the association of permissions and/or rules to such aliases. For example, the determination of what aliases to use may be based on a geographical location and/or time window where the user may be, and/or the identity of the caller trying to reach a reachable user, and/or other factors such as the application/platform used by the originating subscriber to reach the user. These aliases may be associated with a single user identifier. The conditions that enable the system to associate an alias to a user identifier may be termed a reachability context.

An RMF may keep track of reachability, availability, status, and/or presence of devices, platforms, applications, and/or domains associated with a user. The RMF may perform mapping of a common user identifier across devices, platforms, applications, domains, and/or reachability context. The RMF may play a role for managing user reachability, establishing user connectivity and/or maintaining user privacy, and/or handling the association of aliases and/or user identifiers to a reachability context. Additionally or alternatively (e.g., in addition to privacy protection), the RMF may mitigate signaling storms that may be generated by a user (e.g., malicious or not), and/or may cause Denial of Service conditions in the network.

RMF functionality may be implemented as a standalone service (e.g., an application function and/or network function), that the embodiments proposed herein may represent RMF as a standalone service (e.g., the RMF NF and/or RMF enablement server AF), and/or that the RMF may be implemented as an extension to an existing service. For example, the RMF may be collocated with the network data analytics function (NWDAF) NF.

Embodiments are described herein to reach a desired user with an alternative reachability method. A calling UE may interact with the RMF to obtain alternate reachability information about a reachable user. The calling UE may use the obtained alternate reachability information to establish connectivity using an alternative method based on the obtained alternate reachability information and/or the reachable user preferences. The alternate reachability information may include a TSR token and/or may be provided within a TSR token. A network-related embodiment may be implemented in which the network (e.g., RMF) implements logic for determining an alternate and/or preferred method to reach a reachable user.

RMF Information Flows are described herein. RMF registration information may be stored in the RMF and/or the UDM/unified data repository (UDR). The registration information may indicate capabilities of a UE, user and/or device to receive calls, and/or may provide the information for establishing communication using an alternative methods. Additionally or alternatively, the registration information may provide preferences of a user for receiving calls.

The RMF registration information may include certain types of information (e.g., as described herein). For example, the RMF registration information may include RMF device information. The RMF device information may provide information about devices that may be used to reach a user. This information may be a list of devices. The following information may be provided for each device, a device identifier, and/or the technologies used for reaching the device. For example, the technologies for reaching the device may indicate that the device supports calling via the AMF, IMS calling, VoIP calling, and/or calling via different Application Functions (e.g., each AF is indicated).

The RMF registration information may include RMF connectivity information. The RMF connectivity information may provide information about the connectivity associated with the devices and/or related to the reachability technologies provided in the RMF device information. For example, the device connectivity information may indicate that for a given application (e.g., AF) the connectivity may be established over the cloud and/or may provide the endpoint to reach the AF. In examples, the connectivity information may indicate the support for VoIP calls and/or may provide information on how to reach the VoIP gateway.

The RMF registration information may include RMF application information. The RMF application information may provide information about the application associated with the reachability technologies. The information may include applications client identifiers (e.g., application residing on a UE), application server identifiers, including information for contacting the application server. This information may be used by the RMF to identify a common alternative reachability technology for connecting devices.

The RMF registration information may include RMF identity information. The RMF identity information may provide information about the one or more identities that are associated with a user. These identifiers may be the identifiers that are included to reach a user using an alternate communication method and/or that may not be shared with a calling user. The RMF may, for example, use this information for obtaining alternate reachability information and/or a TSR token that allows a calling user to reach a reachable user (e.g., as described herein).

The RMF registration information may include RMF reachability preferences. The RMF reachability preferences may provide information indicating the preference of a user on its reachability. For example, this information may indicate conditions, rules, and/or permissions for using alternative reachability technologies to reach a user. RMF reachability preferences may define priorities when one or more alternative technologies are registered, preferred network operator, access technology, etc. These characteristics may be embodied as a reachability context associated to single user.

A Temporary Secure Reachability (TSR) token may be provided for establishing connectivity via an alternative reachability method. The TSR security token may be formulated (e.g., generated and/or provided) by the AF and/or another server (e.g., RMF) with the capability to issue security tokens and/or to authorize reachability operations. The TSR token may be sent to the calling party (e.g., the calling UE) along with an associated alternative reachability information, such as an alternate reachability method (e.g., associated AF) for reaching a desired party. The TSR token may be granted by an authorization server, for example, an OAuth 2.0 capable server. For example, the TSR token may be in the form of JSON Web Tokens (JWT), and/or may include a header, a payload, and/or a signature.

The TSR token may include a self-contained access token that carries alternate reachability information using claims. The alternate reachability information may describe information related to the token usage. The alternate reachability information and/or TSR token may identify a communication session to be established between a calling party and a called party. The alternate reachability information and/or TSR token may be associated with a communication mechanism. For example, the TSR token may include scope (e.g., as described herein) that details the condition(s) of the token usage. The communication mechanism may include an Application Function (AF) capable of contacting a called party. The terms AF and AS may be used interchangeably herein. The alternate reachability information and/or TSR token may include information about the called party. Additionally or alternatively, the alternate reachability information and/or TSR token may include information with respect to preserving the called party privacy by including a temporary and/or anonymous identifier that may be associated with the called party identifier, and/or associate to alias that may be valid (e.g., only) for the life time of the alternate reachability information and/or TSR token. For example, the caller may be provided with alternate reachability information and/or a TSR token including a temporary identifier; the temporary identifier may be associated with a called party; (e.g., only) the AF that may have issued the alternate reachability information and/or the TSR token may be able to associate the temporary identifier with the called party identifier; and/or the caller may use the alternate reachability information and/or provide the TSR token to the AF to establish a connection to the called party.

The alternate reachability information and/or TSR token may be temporary such that it may identify a communication session between two parties using a given communication mechanism. The alternate reachability information and/or TSR token may become invalid after the communication session is established. The validity of the alternate reachability information and/or TSR token may be for one or more communication session(s). The one or more sessions may be determined by the issuer of the alternate reachability information and/or TSR token based on configuration. The validity criteria of the alternate reachability information and/or TSR token may be indicated in the alternate reachability information and/or in the TSR token.

The TSR token may include information (e.g., as described herein).

The alternate reachability information and/or TSR token may include resource owner. The resource owner may identify the called party. This value may be the known identifier that a caller party uses to establish a communication session with a called party. For example, the called user assigned phone number may be used as the resource owner. The recipient of the alternate reachability information and/or TSR token may use the resource owner to associate a received alternate reachability information and/or TSR token with an ongoing call establishment. This information may be the (e.g., only) identifier that the calling party knows about the called party and/or may be different from the called party identifier used for an alternate communication mechanism.

The alternate reachability information and/or TSR token may include an alternate identifier. The alternate identifier may identify a called party (e.g., either) openly and/or anonymously on the associated alternate communication mechanism. For examples a GPSI, a called user assigned phone number, a TMSI and/or a temporary anonymous ID, and/or alias, issued by an AF and/or an RMF, may identify a called party on an alternate communication mechanism. This information may be used when establishing a communication session via the alternate communication mechanism. When the identifier is a temporary and/or anonymous identifier, for example, the association with the called party identifier may be resolved by the issuer of the anonymous identifier (e.g., an AF, the RMF, the core network, etc.).

The alternate reachability information and/or TSR token may include an alternate identifier issuer. The alternate identifier issuer may identify the issuer of the alternate identifier when the alternate identifier is anonymous and/or temporary. This information may be used by the entity establishing the communication session to obtain the called party identifier for establishing the session.

The alternate reachability information and/or TSR token may include privilege(s) information. The privileges information may indicate the usage of the alternate reachability information and/or TSR token. For example, privilege information may indicate that the privilege is to establish a connection with a user, and/or the privilege may indicate that the token may be used to receive a call from the user. The privilege information may be used to identify how to use the token, for example establish connectivity for an outgoing call, and/or establish connectivity for an incoming call. The privilege information may indicate the number of times the token can be used.

The alternate reachability information and/or TSR token may include a type. The type may indicate that the alternate reachability information and/or TSR token is for reachability. The type may differentiate the alternate reachability information and/or TSR tokens from other types of information and/or tokens that may be used for other purposes. For example, the alternate reachability information and/or TSR token type may indicate authorization purposes. For example, the alternate reachability information and/or TSR token type may indicate privacy purposes. For example, the TSR token may be associated with authorization, and/or privacy may be achieved using an anonymous ID in the token.

The alternate reachability information and/or TSR token may include the expiration information. The expiration information may indicate the validity time of alternate reachability information and/or TSR token. This information may be used to validate if alternate reachability information and/or TSR token can be used.

The alternate reachability information and/or TSR token may include issuer information. The issuer information may identify the issuer of the alternate reachability information and/or TSR token. This information may be used to identify how to resolve the alternate reachability information and/or TSR token alternate identifier when a temporary and/or anonymous identifier is used. The alternate reachability information and/or TSR token issuer may be capable of associating the temporary and/or anonymous identifier with the called party identifier.

The alternate reachability information and/or TSR token may include the subject. The subject may identify the party that may initiate the call and/or to which the alternate reachability information and/or TSR token has been provided. This information may be used to validate a received alternate reachability information and/or TSR token.

The alternate reachability information and/or TSR token may include the audience. The audience may identify an AF and/or NF and/or service that has been determined as an alternative communication mechanism. This information may be used to establish communication with a called party by using the alternate reachability information and/or sending the TSR token.

The alternate reachability information and/or TSR token may include the scope. The scope may include parameters and/or conditions associated with the alternate reachability information and/or TSR token usage and/or limits. This information may be used to determine alternate reachability information and/or TSR token validity and/or whether alternate reachability information and/or TSR token may be used. For example, the scope may be a duration, time of day, location, a maximum number of usage, etc.

When receiving a request from the client, the authorization server may (e.g., first) authenticate the client, and/or may determine the authorization if the calling party is permitted to connect to the reachable UE based on operator's policies and/or the rules and/or authorization that is provisioned by the reachable UE based on the who/when/where/how the calling party can connect to the reachable UE with the reachability. The conditions can be formulated as the scope in the alternate reachability information and/or TSR token.

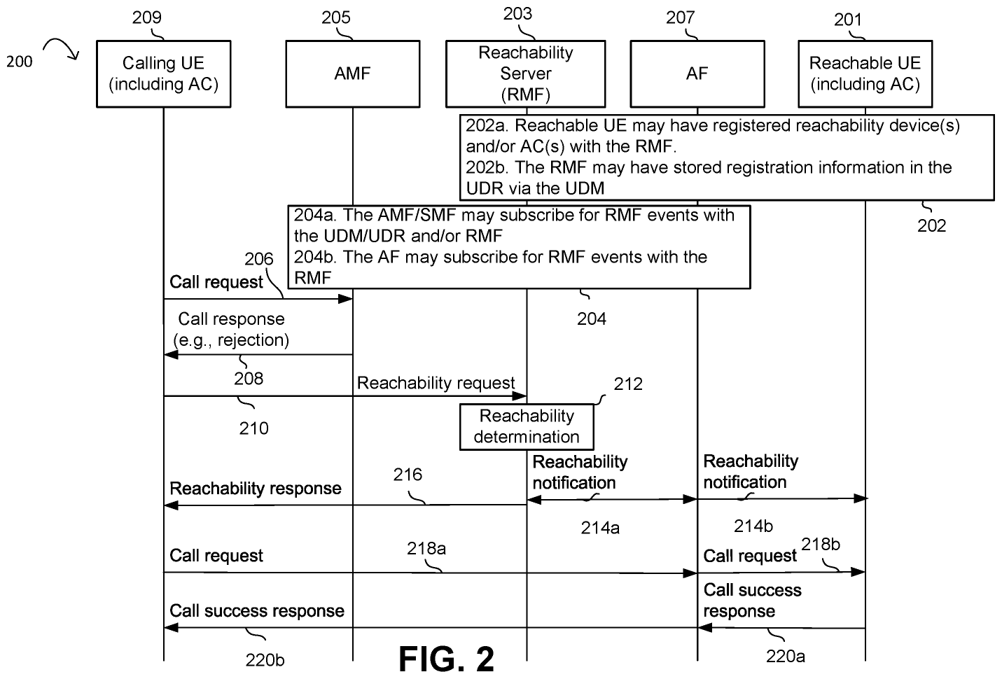

Embodiments are described that relate to RMF alternate reachability by the UE consumer. FIG. 2 is a call flow diagram 200 that illustrates an example process for a WTRU connection establishment via an alternative reachability method from a reachability management function (RMF). FIG. 2 depicts a procedure to provide alternate reachability between Ues when the calling UE uses RMF capabilities.

At 202, the reachable UE 201 may register (e.g., at 202a) identifier(s) for reaching device(s) and/or application client(s) with the RMF 203. The reachable UE 201 may register to the network by sending a UE registration request to the AMF 205, and/or the reachable UE 201 may receive in the registration accept request from the AMF 205 information about the RMF 203. The user may register each of the devices, with each device associated with a network, security server, user ID, rules and/or conditions to be reached, priority, etc. The RMF 203 may keep the reachability information and/or may receive information update(s). When a request for reachability is received, for example, the RMF 203 may authenticate the request, and/or may locate the reachability that matches the rules and/or permissions and/or priority. The RMF 203 may respond with one or more reachability(ies) with the TRS token that the calling UE 209 can reach the reachable UE 201. The RMF 203 may be determined and/or selected by the AMF 205 as part of the AMF 205 processing the UE registration procedure and/or may be a known network function that is retrieved by the AMF 205 from the network repository function (NRF), UDM configuration. The RMF 203 may be an AF 207 (e.g., trusted or not) that has registered with the core network (e.g., via the NEF if needed) to provide the reachability service to the core network.

The reachable UE 201 may use the RMF information to access the RMF 203 to register (e.g., store) the alternate reachability information. As described herein, the registration request may include reachable UE 201 alternate reachability information used to determine alternative ways of contacting the reachable UE 201 and/or may configure permissions and/or rules to control the reachability of the reachable UE 201. For example, the UDM may include the network information in which the UE is registered. For example the UDM may include the Public Land Mobile Network (PLMN) identifier of the PLMN that the UE is roaming to. If the UE is roaming to another country that charges more using 5G calling, the UE may prefer to be contacted by VoIP call and/or an application call for a regular call. If the call is from a trusted source, such as a family member, for example, the user may take the call with any reachability method at any time and/or at one or more locations. For example, the information may include the information provided by the reachable UE 201 about the alternate reachability methods (e.g., communication media, messaging services, multimedia services, and/or application layer software services). Alternate reachability methods may include alternate reachability methods identifiers for each of the alternate reachability methods, policies and/or validity conditions for selecting and/or using each of the alternate reachability methods (e.g., time, location, device, etc.). The RMF 203 may store (e.g., at 202b) the reachable UE 201 alternate reachability information in the UDR by contacting the UDM, and/or the RMF 203 may (e.g., at any time) update the UDM/UDR with changing information related to the reachable UE 201 information. The RMF 203 may create and/or update a subscription with other NFs and/or AFs such that they may be notified of events related to the reachability, availability, status, and/or presence of the reachable UE 201. For example, the RMF 203 may register to the UDM to receive (e.g., external, NWDAF) parameters (e.g., expected UE moving trajectory, communication duration time, periodic time, scheduled communication type, expected time and day of week in trajectory, network performance analytics, UE-related analytics, user data congestion analytics, etc.) related to the expected location of a UE, and/or may register to receive analytics notification from the NWDAF to received expected UE location. Expected UE moving trajectory may identify the expected geographical movement and/or path of movement of the UE. Communication duration time may indicate how long the UE is expected to stay in CM-CONNECTED for data transmission. Periodic time may indicate the expected interval time for periodic communication. Scheduled communication time may indicate the expected time and/or day of the week when the UE is available for communication. Scheduled communication type may indicate the expected communication type (e.g., downlink, uplink, and/or bi-directional). Expected time and/or day of week in trajectory may identify the time and/or day of the week when the UE is expected to be at each location included in the expected moving trajectory. Network performance analytics may provide (e.g., either) statistics and/or predictions on the gNB status, gNB resource usage, communication performance, and/or mobility performance in an area of interest. Additionally or alternatively, statistics and/or predictions on the number of UEs located in an area of interest may be provided. UE-related analytics may provide (e.g., either) statistics and/or predictions on UE mobility, UE communication, expected UE behavioral parameters, and/or abnormal UE behavior. User data congestion analytics may provide statistics and/or predictions on congestion experienced while transferring user data over the control plane and/or user plane and/or may be related to a specific area. One or more other events may include availability, presence, status (e.g., busy, idle no interruption, calendar events, power on/off, etc.

Registration operation described herein may allow registration updates for modifying (e.g., updating, deleting) the stored alternate reachability information. The registration application programming interfaces (API) semantics may, for example, follow principles of a Create-Read-Update-Delete (CRUD) API for managing resources, and/or the resources managed may be the stored alternate reachability information.

At 204, the AMF 205 and/or SMF may subscribe (e.g., at 204a) with the UDM and/or the RMF 203 to receive notification about RMF events and/or when the reachability information is updated. The AF instances that require knowing about RMF events and/or information may subscribe (e.g., at 204b) with the UDM and/or the RMF 203 to receive RMF events if RMF information is updated. The AF subscription may be via the NEF if the AF is untrusted.

At 206, the calling UE 209 may issue a Call request using the reachable UE 201 known identifier (and/or the identifier known to the calling UE 209). The identifier may be the reachable UE 201 mobile phone number and/or the GPSI, and/or the identifier may have been pre-provisioned, and/or user provided on the calling UE 209 as the known identifier for the reachable UE 201. For example, the calling UE may use the identifier (e.g., mobile phone number) to contact the reachable UE. Upon receiving the call request, for example, the AMF 205 may determine with the assistance from RMF 203 whether the reachable UE 201 is available using the provided identifier from the request 206 and/or may establish connectivity with the reachable UE 201.

At 208, if the AMF 205 determines that the reachable UE 201 is not reachable via the identifier received on the request (e.g., at 206) from the calling UE 209, for example, the AMF 205 may send a Call response 208 to the calling UE 209. The Call response 208 may indicate a call rejection. The Call response 208 sent by the AMF 205 may include RMF information. For example, the Call response may indicate that the reachable UE 201 has configured alternate reachability information in the system. For example, the RMF 203 may be the central location for determining the reachability of the reachable UE 201. The AMF 205 may contact the RMF 203 for reachability. The AMF 205 may not have the complete view and/or updated information indicating whether the reachable UE 201 is able to be reached. The AMF 205 may not have information of the reachable UE 201 that is located in a different part of a network, for example. The AMF 205 may have the information of UE(s) that is covered by the AMF 205. The AMF 205 may determine an alternate reachability method (e.g., communication media, messaging services, multimedia services, and/or application layer software services) from the UDM and/or RMF 203. For example, the AMF 205 may have determined alternate an reachability method from the UDM and/or RMF 203 by receiving a notification for RMF information and/or requesting RMF information. For example, the Call response may provide RMF connectivity information for using the alternate reachability information and/or alternate reachability methods (e.g., communication media, messaging services, multimedia services, and/or application layer software services) supported by the reachable UE 201. RMF connectivity information may have been alternatively configured on the calling UE 209, for example, via pre-provisioning and/or via the registration procedure with the network. If the AMF 205 determines that the reachable UE 201 is not reachable, for example, the reachable UE 201 may not be aware that the calling UE 209 is attempting to contact the reachable UE 201.

At 210, upon receiving the call rejection from the AMF 205, the calling UE 209 may use the RMF information provided in the Call response (e.g., 208) to attempt to contact the reachable UE 201 via one or more alternative mechanisms. Based on the RMF information received (e.g., at 208), for example, the calling UE 209 may send a Reachability request 210 to the RMF 203. The Reachability request 210 may include the reachable UE 201 known identifier used herein (e.g., at 206). The Reachability request 210 may include the calling UE 209 known identifier and/or a list of reachability that the calling UE 209 supports. The list of reachability may include one or more (e.g., alternative) reachability methods (e.g., alternate reachability information). The list of reachability and/or (e.g., alternative) reachability methods may include a list of communication capabilities that the entity (e.g., reachable UE 209) can be reached. The reachability request may include the known identifier, an identifier of the calling UE 209, and/or information about one or more capabilities (e.g., of the calling UE 209 and/or reachable UE 201). Additionally or alternatively, the known identifiers (e.g., from the calling UE 209 and/or reachable UE 201) may be used by the RMF 203 to determine the compatible alternative methods for connecting both UEs (e.g., Calling UE 209 and/or Reachable UE 201) if the calling UE 209 has registered with the RMF 203.

At 212, the RMF 203 may perform a reachability determination. For example, upon receiving the Reachability request 210 from the calling UE 209, the RMF 203 may verify if the calling UE 209 is authorized to contact the reachable UE 201 using an alternate mechanism (e.g., based on the reachable UE 201 alternate reachability information, e.g. permission rules, received during RMF registration and/or provided on the reachability request). For example, the TSR token may be formulated by the RMF 203 after the checking of the permission rule(s) and/or reachability conditions. Additionally or alternatively, the reachable UE 201 may provide (e.g., at 202) the alternate reachability information, including rules. The RMF 203 may validate the reachability request 210 to determine whether the reachability request 210 satisfies (e.g., is okay) according to the alternate reachability information (e.g., rules). Additionally or alternatively, the RMF 203 may consider the information included in the reachable UE 201 RMF registration (e.g., application identifiers, time of day, location, etc.) to determine if the calling UE 209 and reachable UE 201 have a common alternative reachable mechanism. The RMF 203 may determine that the calling UE 209 may connect to the reachable UE 201, and/or may determine a common alternate communication mechanism, and/or may obtain (e.g., from the UDM and/or UDR) information associated with both UEs (e.g., Calling UE 209 and/or Reachable UE 201) and/or the associated AF.

At 214a, the RMF 203 may use the information associated with the common alternate mechanism to notify the AF 207 associated with the common alternate mechanism about the reachability event. Upon receiving the reachability notification from the RMF 203, the AF 207 may validate if the calling UE 209 and/or the reachable UE 201 are allowed to communicate. The AF 207 may determine alternate reachability information associated with reachable UE 201 and/or may issue Temporary Secure Reachability (TSR) tokens for (e.g., either, both) the calling UE 209 and/or the reachable UE 201 for establishing the connectivity. For example, the TSR token may be issued by the authorization server after authenticating the requester. The TSR token may include alternate connectivity information. In examples, the RMF 203 may be the authorization server and/or work with the authorization server to issue the token. The AF 207 may help the authorization decision of the RMF 203, for example, by sending (e.g., additional) information (e.g., security policy) to the RMF 203 on the user reachability permission. The (e.g., final) decision may be made by the RMF 203. The TSR token may be used for the authorization. The TSR information may include privacy information. For example, the privacy information (e.g., anonymous ID) can be used in the token. The terms privacy information and security information may be used interchangeably herein. The alternate reachability information and/or TSR token may be (e.g., only) valid for the duration of the connection between the first WTRU and second WTRU. For example, the alternate reachability information and/or TSR token may expire after the conclusion of the established call between the first and second WTRU. At 214b, the AF 207 may notify the reachable UE 201 about the upcoming connection request and/or may provide the alternate reachability information and/or TSR token of the reachable UE 201 and/or information to validate that (e.g., future) incoming connection request. The AF 207 may assign an anonymous ID associated with the called user to be used by the calling UE 209, and/or may keep the ID mapping between the anonymous ID and user ID. For example, an anonymous ID may be assigned for privacy purposes of the reachable UE 201. The anonymous ID may be sent back to the calling UE 209 in the alternate reachability information and/or TSR token. The AF 207 may have registered for RMF events (e.g., at 204b).

Additionally or alternatively (e.g., to 214b), the alternate reachability information and/or TSR token may be sent to the reachable UE 201 after procedures 214a and/or 214b, and/or may be sent by the RMF 203, and/or by the AMF 205 (e.g., notified by the RMF 203) via the non-access stratum (NAS) protocol, and/or may be issued by (e.g., either of) the RMF 203 and/or the AMF 205.

At 216, the RMF 203 may send a Reachability response to the calling UE 209. The Reachability response may include the alternate reachability information and/or TSR token for the calling UE 209 and/or information about the selected alternative mechanism for contacting the reachable UE 201. For example, the TSR token may include information about privacy information (e.g., the anonymous ID, of the calling and/or reachability WTRU), and/or verification information (e.g., to authorize the connection between the calling WTRU and the reachable WTRU). Upon receiving the response with alternate reachability information and/or TSR token and/or alternative mechanism, the calling UE 209 may provide the alternate reachability information and/or TSR token to the determined AC. The Reachability response 216 and/or the alternate reachability information and/or the TSR token may include the conditions for using the alternate reachability information and/or TSR token (e.g., a delay and/or time in which the alternate reachability information and/or TSR token may be used, and/or a location where the alternate reachability information and/or TSR token may be used). For example, the alternate reachability information and/or TSR token may indicate that the calling UE 209 may (e.g., only) be authorized to establish a connection with the reachable WTRU under one or more conditions (e.g., location of the calling WTRU and/or reachable UE, time of day, etc.). If the reachability response 216 indicates that the RMF 203 determination (e.g., at 212) was unsuccessful (e.g., the RMF was unable to determine a match of the reachability of reachable UE 201, the calling UE 209 does not support a software application), the reachability response may indicate for the calling UE 209 to send another reachability request (e.g., similar to 210) to the RMF 203 to get another alternative reachability method. Processes 210 to 216 may be performed iteratively, for example, until the RMF 203 determines one or more alternative reachability methods.

At 218a, the determined AC on the calling UE 209 may send a Call request to its associated AF 207 using the alternate reachability information and/or TSR token and/or anonymous ID received (e.g., at 216). The Call request 218a may be based on alternate reachability information and/or TSR token, and the TSR token may be included in the Call request 218a. Upon receiving the Call request 218a from the calling UE 209, for example, the AF 207 may verify the validity of the alternate reachability information and/or TSR token included in the Call request 218a (e.g., using information provided to the AF at 214a) and/or may use the alternate reachability information and/or TSR token to determine the secured identities of the calling UE 209 and/or reachable UE 201. After authenticating the calling UE 209 and/or authorizing the connection request from the calling party, for example, the AF 207 may map the anonymous ID in the request to the ID for the reachable UE 201 and/or may make the connection to the reachable UE 201. For example, the AF 207 may map the anonymous ID of the reachable UE 201 to preserve anonymity of the reachable UE 201 when the calling UE 209 establishes a connection/call.

At 218b, the AF 207 may send a Call request to the reachable UE 201 if the alternate reachability information and/or TSR token is valid. The Call request 218b may be based on the alternate reachability information and/or TSR token, and may include the TSR token (e.g., including the validity timer of the TSR token). of the calling UE 209. Upon receiving the Call request 218b, for example, the reachable UE 201 may determine if the incoming call is valid using (e.g., both) the calling UE 209 provided alternate reachability information and/or TSR token and/or the reachable UE 201 TSR token.

At 220a, the reachable UE 201 may send a Call success response to the AF 207, for example, based on the validation performed (e.g., at 218a, 218b). At 220b, the AF 207 may send a Call success response to the calling UE 209 to indicate the success and/or may establish call connectivity between both UEs (e.g., between Calling UE 209 and Reachable UE 201).

The Call rejection (e.g., at 208) may not be indicated to the calling user, and/or that procedures (e.g., 210, 212, 214a, 214b, 216, 218a, 218b, 220a, and/or 220b) may happen in the background and/or may appear as call establishment procedures to the calling user. The Registered devices (e.g., at 202a) may maintain their reachability with the AF 207, and/or the AF 207 may update the RMF 203 accordingly. The Reachability request (e.g., at 210) may happen on the user plane and/or via the NAS protocol.

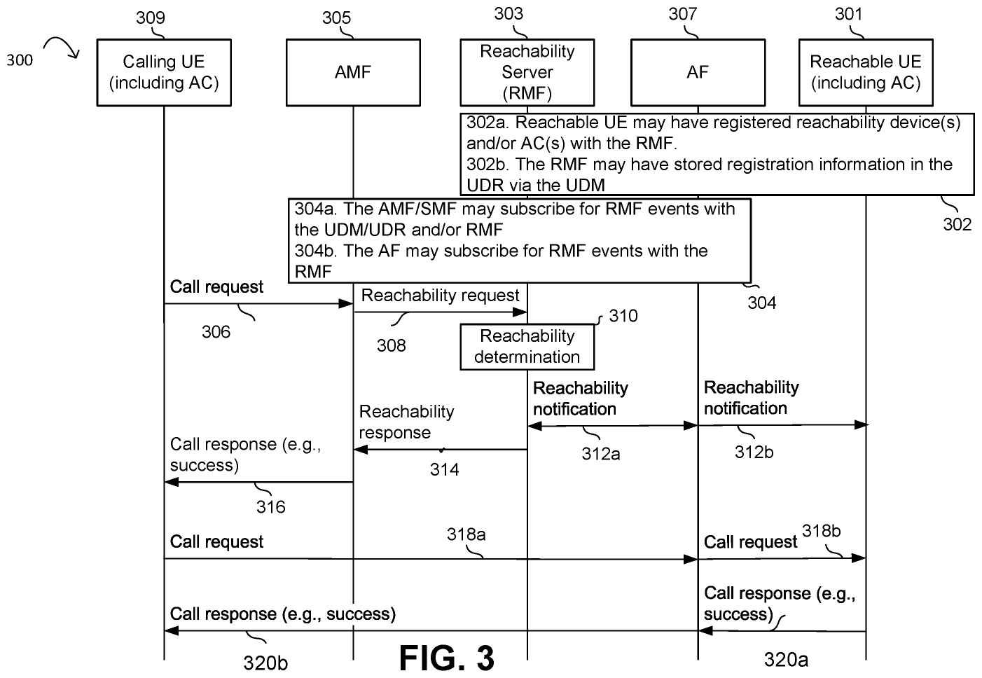

FIG. 3 is a call flow diagram 300 that illustrates an example process of RMF alternative reachability connection establishment by the network consumer (e.g., AMF 305). FIG. 3 presents a procedure to provide one or more alternate reachability methods (e.g., communication media, messaging services, multimedia services, and/or application layer software services) between UEs (e.g., calling UE 309 and reachable UE 301) when the AF 307 uses one or more RMF 303 services. The AMF 305 may be one possible network consumer of the RMF 303. Other network consumers may include, for example, a VoIP gateway, CSCF server for IMS services, etc. One or more other network consumers may be based on what network service the calling UE 309 is using.

At 302, the reachable UE 301 may register (e.g., at 302a) identifier(s) for reaching device(s) and Application Client(s) (AC) with the RMF 303. The RMF 303 may store (e.g., at 302b) the registration information in the UDR via the UDM. One or more procedures at 302 may be the same as described herein (e.g., at 202, 202a, and/or 202b of FIG. 2).

At 304, the AMF 305 and/or SMF may subscribe (e.g., at 304a) with the UDM and/or the RMF 303 to receive notification about RMF events and/or when the registration information is updated. The AF 307 instances that require knowing about RMF 303 events and/or information may subscribe (e.g., at 304b) with the UDM and/or the RMF 303 to receive RMF events if RMF information is updated. For example, the AF may subscribe to RMF 303 events. To receive notification (e.g., at 312a), the AF 307 may be subscribed to RMF 303 events (e.g., if calling UE 309 is trying to alternately reach the reachable UE 301). The AF 307 instances can update the UE reachability 301 on the RMF 303. The AF 307 subscription may be via the NEF, for example, if the AF 307 is untrusted. This procedure may be the same procedure as described herein (e.g., at 204, 204a, and/or 204b of FIG. 2).

At 306, the calling UE 309 may issue a call request using the reachable UE 301 known identifier. The identifier may be the reachable UE 301 mobile phone number and/or the GPSI. The identifier may have been pre-provisioned, and/or user provided on the calling UE 309 as the known identifier for the reachable UE 301. Upon receiving the call request 306, for example, the AMF 305 may determine whether the reachable UE 301 is available using the provided identifier (e.g., the known identifier) from the call request and/or may establish connectivity with the reachable UE 301.

If the AMF 305 determines that the reachable UE 301 is not reachable via its known identifier, for example, the AMF 305 may determine if the reachable UE 301 has configured one or more alternate reachability identifiers in the system. The AMF 305 may determine the alternate reachability identifier(s) from the UDM and/or RMF 303. For example, the AMF 305 may determine the alternate reachability identifier(s) from the UDM and/or RMF 303 by receiving a notification for RMF information and/or requesting RMF information. The AMF 305 may determine RMF 303 connectivity information for using the alternate reachability information and/or alternate reachability methods (e.g., communication media, messaging services, multimedia services, and/or application layer software services) supported by the reachable UE 301.

The calling UE 309 may include its known identifier and/or may include RMF capabilities of the calling UE 309 in the call request 306. The AMF 305 may determine capabilities of the calling UE 309 based on the RMF information of the calling UE 309 obtained from the UDM and/or RMF 303 and/or the calling UE 309 known identifier. The AMF 305 may use the calling UE 309 RMF capabilities if provided in the request (e.g., calling request at 306).

At 308, based on the RMF information determined by the AMF 305, for example, the AMF 305 may send a Reachability request to the RMF 303. The request may include the reachable UE known identifier received (e.g., at 306). The Reachability request 308 may include the calling UE 309 known identifier if received (e.g., at 306). The known identifiers (e.g., from the calling UE 309 and/or the reachable UE 301) may be used by the RMF 303 to determine the compatible alternative methods for connecting both UEs (e.g., calling UE 309 and/or the reachable UE 301), for example, if the calling UE 309 has registered with the RMF 303. Additionally or alternatively, the AMF 305 may include RMF 303 capabilities of one or more (e.g., both) UEs (e.g., calling UE 309 and/or reachable UE 301) if determined (e.g., at 302).

At 310, the RMF 303 may verify if the AMF 305 is authorized. For example, upon receiving the Reachability request 308 from the AMF 305, the RMF 303 may verify if the AMF 305 is authorized to perform this request for the calling UE 309 and/or if the calling UE 309 is authorized to contact the reachable UE 301 using an alternate mechanism (e.g., based on registration). For example, the reachable UE 301 can configure the permission rules on a specific calling UE (e.g., 309), a group UE, a white list, a black list, and/or a combination. IF a UE is not in one or more (e.g., any) match, the default action can be permitted/denied. Additionally or alternatively, the RMF 303 may consider that the reachability information included in the reachable UE 301 registration request (e.g., such as time of day, location, etc.) and/or may determine if the calling UE 309 and reachable UE 301 have a common alternative reachable mechanism. If the RMF 303 determines that the calling UE 309 may connect to the reachable UE 301, and/or determines a common alternate communication mechanism, the RMF 303 may obtain (e.g., from the UDM/UDR) information associated with the common alternate mechanism (e.g., identifiers for both UEs and/or the AF 307). For example, the RMF 303 may obtain identifiers for both UEs (e.g., calling UE 309 and/or reachable UE 301) and/or identifiers associated with the AF 307. For example, the RMF 303 may obtain identifiers based on the calling UE 309 ID and/or one or more permission rules of the reachable UE 301.

At 312a, the RMF 303 may use the information associated with the common alternate mechanism to notify the AF 307 associated with the common alternate mechanism about the reachability event. Upon receiving the reachability notification from the RMF 303, for example, the AF 307 may validate if the calling UE 309 and/or the reachable UE 301 are allowed to communicate. The AF 307 may issue alternate reachability information and/or Temporary Secure Reachability (TSR) tokens for the calling UE 309 and/or the reachable UE 301 for establishing the connectivity. The alternate reachability information and/or TSR token may indicate privacy information (e.g., anonymous ID of the reachable UE 301), authorization information (e.g., to establish a call between the calling UE 309 and the reachable UE 301), and/or validity information (e.g., as described herein). At 312b, the AF 307 may notify the reachable UE 301 about the upcoming connection request and/or may provide the alternate reachability information and/or TSR token of the reachable UE 301 and/or information to validate that (e.g., future) incoming connection request. The response from AF 307 may include alternate reachability information and/or TSR token and/or an anonymous ID for the called user. For example, if the AF 307 may serve as an authorization server, the (e.g., TSR) token can be issued by the AF 307. Additionally or alternatively, the AF 307 may send the anonymous ID to the RMF that includes the anonymous ID into the TRS token issued by the RMF 303. In examples, the AF 307 can validate the token signature by the RMF 303 when the AF 307 receives a call from the calling UE 309. The (e.g., TSR) token may include a parameter for the valid time that controls the expiring time of the (e.g., TSR) token. The anonymous ID may be used by the calling UE 309 to reach the called user. When the AF 307 receives the request (e.g., at 318a), for example, the AF 307 can map the anonymous ID to the user ID.

The AF 307 may have registered for RMF events (e.g., at 304b). Additionally or alternatively (e.g., to 312b), the alternate reachability information and/or TSR token may be sent to the reachable UE after 312a and/or 312b, and/or may be sent by the RMF 303, and/or by the AMF 305 (e.g., notified by the RMF 303) via the NAS protocol, and/or may be issued by (e.g., either of) the RMF 303 and/or the AMF.

At 314, the RMF 303 may send a Reachability response to the AMF 305. The Reachability response 314 may include the alternate reachability information and/or TSR token for the calling UE 309 and/or information about the selected alternative mechanism for contacting the reachable UE 301.

At 316, if the AMF 305 has obtained alternate reachability information and/or TSR token for the calling UE 309 and/or information about the selected alternative mechanism (e.g., at 314), for example, the AMF 305 may send a successful call response to the calling UE 309 indicating the alternate mechanism for reaching the reachable UE 301. The call response 316 may be based on alternate reachability information and/or TSR token, and/or may include the TSR token for the calling UE 309, information about the selected alternative mechanism for contacting the reachable UE 301, authorization information, privacy information, and/or validity timer information. For example, some of the information may be included inside the TRS token. For example, the call response and/or the alternate reachability information and/or TSR token may include the conditions for which this alternate reachability information and/or TSR token can be used (e.g., duration and/or time in which this alternate reachability information and/or TSR token can be used, and/or the location where the alternate reachability information and/or TSR token may be used). Upon receiving the response with alternate reachability information and/or TSR token and/or alternative mechanism, for example, the calling UE 309 may provide the alternate reachability information and/or TSR token to the determined AC.

At 318a, the determined AC on the calling UE 309 may send a Call request to its associated AF 307 using the alternate reachability information and/or TSR token and/or an anonymous ID. At 318b, the request may be based on alternate reachability information and/or TSR token, and/or the TSR token may be included in the request, and/or the AF 307 may send a Call request to the reachable UE 301, for example, if the alternate reachability information and/or TSR token is valid and/or the Call request may be based on alternate reachability information and/or TSR token and may include the TSR token of the calling UE 309. The AF 307 may (e.g., first) resolve the anonymous ID into the user ID and/or may connect to the reachable user using the resolved ID. This procedure may be similar to one or more procedures described herein (e.g., at 218a, 218b).

Additionally or alternatively (e.g., as an alternative to procedure(s) 316 and/or 318a), the AMF 305 may avoid procedure 316 and/or may (e.g., directly) make the connection request to the AF 307 on behalf of the calling UE 309. In examples, the call request (e.g., at 318a) may be initiated by the AMF 305 toward the AF 307 without the calling UE 309 aware of the reachability of the reachable UE 301.

At 320a, the reachable UE 301 may send a Call success response to the AF 307, for example, based on the validation performed (e.g., at 318a and/or 318b). At 320b, the AF 307 may send a Call success response to the calling UE 309 to indicate the success and/or may establish call connectivity between both UEs (e.g., between the calling UE 309 and the reachable UE 301). This procedure may be similar to one or more procedures described herein (e.g., 220a and/or 220b).

Embodiment(s) are be described herein with respect to alternate reachability using reverse calling. For example, call establishment procedures (e.g., 218a, 218b, 318a, and/or 318b) performed by the calling UE (e.g., 209, 309) may be established using a reverse calling strategy.

In one or more (e.g., both) procedures (e.g., 218a, 218b, 318a, 318b), for example, the RMF (e.g., 203, 303) may notify the AF (e.g., 205, 305) (e.g., at 214a, 214b, 312a, and/or 312b) providing alternate reachability information and/or TSR token to the reachable UE (e.g., 201, 301). The reachable UE (e.g., 201, 301) may use the provided alternate reachability information and/or TSR token to establish a call (e.g., a reversed call) to the calling UE (e.g., 209, 309), using the provided alternate reachability information and/or TSR token.

Upon receiving the alternate reachability information and/or TSR token, for example, the reachable UE (e.g., 201, 301) may determine an AC associated with the alternate reachability information and/or TSR token, and/or may provide the alternate reachability information and/or TSR token to the determined AC. The AC may send a Call request to its associated AF (e.g., 207, 307) using the alternate reachability information and/or TSR token and/or anonymous ID. The alternate reachability information and/or TSR token may be included in the request, and/or the AF (e.g., 207, 307) may send a Call request to the calling UE (e.g., 209, 309) if the alternate reachability information and/or TSR token is valid and/or may include the alternate reachability information and/or TSR token of the reachable UE (e.g., 201, 301) in the request. The AF (e.g., 207, 307) may (e.g., first) resolve the anonymous ID into the user ID and/or may establish connectivity using the user ID.

Embodiments described herein may include alternate entities for call establishment. The call initiation procedure (e.g., 206, 306) performed by the calling UE (e.g., 209, 309) may be performed with a different entity than the AMF (e.g., 205, 305). One or more call establishment entities may be described herein.

A call establishment entity may include IP multimedia subsystem (IMS) calling. In IMS calling, the calling UE (e.g., 209, 309) may send a call request to the call session control function (CSCF) to establish an IMS call. The CSCF may attempt to establish the IMS call. The CSCF may subscribe to RMF events and/or may use the RMF service (e.g., similar to the AMF 205, 305) such that the CSCF may discover alternate connectivity if the IMS call cannot be established. The CSCF may (e.g., further) provide the alternate reachability information and/or TSR token to the calling UE (e.g., 209, 309), for example, when an IMS call fails such that the call may be established using an alternate mechanism.

A second call establishment entity option may include VoIP calling. In VoIP calling, the calling UE (e.g., 209, 309) may send a call request to the VoIP gateway to establish a VoIP call. The VoIP gateway may attempt to establish the VoIP call. The VoIP gateway may subscribe to RMF events and/or may use the RMF service (e.g., similar to the AMF 205, 305) such that the VoIP gateway may discover alternate connectivity if the VoIP call cannot be established. The VoIP gateway may (e.g., further) provide the alternate reachability information and/or TSR token to the calling UE (e.g., 209, 309), for example, when a VoIP call fails such that the call may be established using an alternate mechanism.

A third call establishment entity option may include contacting the RMF (e.g., 203, 303) as a network function (e.g., directly). In examples, the network may have capabilities that allow a calling UE (e.g., 209, 309) to reach the RMF (e.g., 203, 303) (e.g., directly) such that the UE, upon establishing a call, may reach to the RMF (e.g., 203, 303) to determine how to reach a reachable UE (e.g., 201, 301) prior to attempting to establish a call. In examples, the call attempt (e.g., 206, 306) may not initially be performed by the calling UE (e.g., 209, 309), and/or the calling UE (e.g., 209, 309) may initially issue a reachability request to the RMF (e.g., 203, 303) as described herein (e.g., at 210) to pre-determine how to reach the reachable UE (e.g., 201, 301). As a result of the pre-determination process, for example, the calling UE (e.g., 209, 309) may initiate a call request with one or more of the AMF (e.g., 205, 305), CSCF, VoIP gateway, and/or an AF (e.g., 207, 307) based on this pre-determination. An advantage of this method may be an increased confidence level when establishing a call.

1. A first wireless transmit/receive unit (WTRU) comprising:
a processor configured to:
send a reachability request to a reachability management function (RMF) in response to receiving the indication that the second WTRU has one or more configured alternate reachability methods, wherein the reachability request comprises information associated with the first WTRU;
receive a reachability response from the RMF that indicates the second WTRU is able to connect with the first WTRU, wherein the reachability response comprises alternate reachability information to connect the first WTRU with the second WTRU via one of the one or more configured alternate reachability methods;
send a call request to an application server (AS) using the alternate reachability information associated with the second WTRU; and
receive a call response that indicates a call is established.

2. The first WTRU of claim 1, wherein the processor is further configured to send the reachability request based on RMF information received or based on the call rejection.

3. The first WTRU of claim 1, wherein the processor is further configured to receive the alternate reachability information at an application client (AC) residing on the first WTRU.

4. The first WTRU of claim 3, wherein the processor is further configured to determine the AC based on information associated with the alternate reachability information.

5. The first WTRU of claim 1, wherein the processor is further configured to send the second call request to the AS based on alternate reachability information.

6. The first WTRU of claim 1, wherein the call response comprises an indication to a user that the call is established.

7. The first WTRU of claim 1, wherein the alternate reachability information comprises a temporary secure reachability (TSR) token, wherein the TSR token comprises authentication information to establish the call associated with the first WTRU or the second WTRU.

8. The first WTRU of claim 1, wherein the alternate reachability information comprises validity conditions that indicates the alternate reachability information validity for establishing a connection between the first WTRU and the second WTRU.

9. The first WTRU of claim 1, wherein the alternate reachability information comprises privacy information associated with the first WTRU or the second WTRU, wherein the privacy information comprises an anonymous identification (ID) associated with the second WTRU, and wherein the processor is further configured to use the anonymous ID to establish the call with the second WTRU.

10. The first WTRU of claim 1, wherein the call response is a first call response, and the call request is a first call request, and wherein the processor is further configured to:
send a second call request wherein the call request indicates a known identifier to reach a second WTRU; and
receive a second call response, wherein the call response indicates a call rejection and an indication that the second WTRU has one or more configured alternate reachability methods, and
wherein the reachability request is triggered by reception of the first call response, and wherein the second call request is sent before the first call request, and wherein the second call response is received before the first call response.

11. The first WTRU of claim 1, wherein the first call request is triggered by a user.

12. The first WTRU of claim 1, wherein the first call response further comprises information about the RMF.

13. The first WTRU of claim 1, wherein the information associated with the first WTRU comprises a known identifier, an identifier of the first WTRU, or one or more capabilities associated with the reachability of the first WTRU.

14. A method performed by a reachability management function (RMF), the method comprising:
receiving a reachability request from a first wireless transmit/receive unit (WTRU) to establish a call with a second WTRU, wherein the reachability request comprises one or more identifiers associated with the first WTRU, second WTRU, or information associated with one or more capabilities of the first WTRU;
sending a reachability notification to an application function (AF), wherein the reachability notification comprises an indication to connect the first WTRU with the second WTRU via one or more configured alternate reachability methods;
receiving a reachability notification response from the AF, wherein the reachability notification response comprises alternate reachability information to use to connect the first WTRU with the second WTRU; and
sending a reachability response to the first WTRU, wherein the reachability response indicates that the first WTRU is connected to the second WTRU.

15. The method of claim 14, wherein the one or more configured alternate reachability methods comprises a common alternative communication method, and wherein the method further comprising determining the common alternative communication method for the first WTRU and the second WTRU based on one or more of a registered alternative method of the one or more configured alternate reachability methods or one or more capabilities of the first WTRU or of the second WTRU.

16. The method of claim 14, further comprising determining the AF based on the determined alternative communication method.

17. The method of claim 14, further comprising determining an identity of the second WTRU pre-provisioned by the second WTRU as an alternate communication method.

18. The method of claim 14, wherein the alternate reachability information further comprises an anonymous identifier of the second WTRU or authentication information to connect the first WTRU with the second WTRU.

19. The method of claim 14, further comprising receiving the reachability request from the first WTRU.

20. The method of claim 19, wherein the reachability request is received based on information sent to the first WTRU or based on a call rejection.

21. The method of claim 14, further comprising using RMF registration information to connect the first WTRU with the second WTRU.

22. The method of claim 19, wherein the RMF registration information comprises RMF device information, RMF connectivity information, RMF application information, RMF identify information, or RMF reachability preferences.

23. The method of claim 14, wherein the alternate reachability information comprises validity conditions, wherein the method further comprising using the validity conditions to connect the first WTRU with the second WTRU.

24. The method of claim 14, wherein the alternate reachability information comprises information associated with one or more of: resource owner, alternate identifier, alternate identifier issuer, privileges, type, expiration, issuer, subject, audience, or scope.

25. The method of claim 14, further comprising determining whether the first WTRU is authorized to connect with the second WTRU is based on operator policies or rules.

26. The method of claim 14, wherein the alternate reachability information comprises privacy information associated with the first WTRU or the second WTRU, wherein the privacy information comprises an anonymous identification (ID) associated with the second WTRU, and the method further comprises using the anonymous ID to establish the call with the second WTRU.

27. The method of claim 14, wherein the alternate reachability information comprises a temporary secure reachability (TSR) token, wherein the TSR token comprises authentication information to establish the call associated with the first WTRU or the second WTRU.
